(19) United States
(12) Patent Application Publication
(10) Pub. No.: US 2025/0013732 A1
(43) Pub. Date: Jan. 9, 2025

(54) IT Security of an Automation System

(71) Applicant: Siemens Aktiengesellschaft, München (DE)

(72) Inventors: Klaus Lukas, München (DE); Christoph Fischer, Untermauerbach (DE); Julio Ricardo Simoes Morais, Mindelo (PT); Marcel Kulicke, München (DE)

(73) Assignee: Siemens Aktiengesellschaft, München (DE)

(21) Appl. No.: 18/702,144

(22) PCT Filed: Oct. 11, 2022
(86) PCT No.: PCT/EP2022/078242

§ 371 Date: Apr. 18, 2024

(30) Foreign Application Priority Data
Oct. 18, 2021 (DE) 10 2021 211 755.4
May 5, 2022 (EP) 22171866.1

(51) Int. Cl. G06F 21/46

(52) U.S. Cl. CPC G06F 21/46

(57) ABSTRACT

Various embodiments of the teachings herein include a method for ensuring security of an automation system. An example method includes: checking a piece of authentication information previously provided for authentication at an end point of the automation system for a minimum security requirement; if the piece of authentication information does meet the minimum security requirement, using an authentication module to authenticate at the end point; else, if the piece of authentication information does not meet the minimum security requirement, generating a new piece of authentication information, and providing the authentication module with the new piece of authentication information to authenticate at the end point.

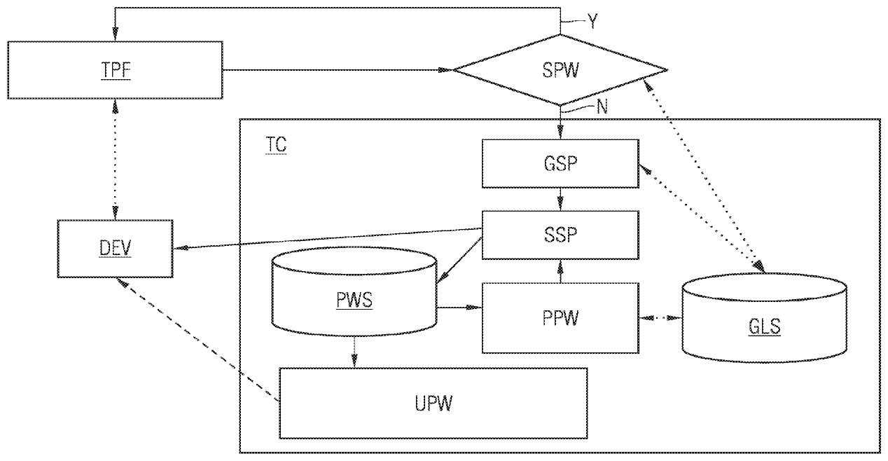

### CROSS-REFERENCE TO RELATED APPLICATIONS

This application is a U.S. National Stage Application of International Application No. PCT/EP2022/078242 filed Oct. 11, 2022, which designates the United States of America, and claims priority to EP Application No. 22171866.1 filed May 5, 2022 and claims priority to DE Application 10 2021 211 755.4 filed Oct. 18, 2021, the contents of which are hereby incorporated by reference in their entirety.

### TECHNICAL FIELD

The present disclosure relates to IT security. Various embodiments of the teachings herein include automation systems, security systems, and/or methods for operating systems.

### BACKGROUND

In industrial plants, devices are regularly protected with passwords. However, in particular in industrial environments, in particular in automation systems, the use of passwords is regularly unwieldy and cumbersome, for example because of prescribed protective wear such as gloves or because of the fact that devices have to be operated in a timely fashion by a plurality of different users. For this reason, in industrial environments passwords are often either not set at all or very short passwords are selected in order to speed up entry. Although, as a rule, additional protective measures of the systems exist, such as firewalls or cell concepts, a basic password protection of automation systems is important for the implementation of a defense-in-depth strategy and makes attacks considerably more difficult.

In classic IT environments, this problem does not generally occur, since here the password complexity is checked during the entry and only sufficiently strong passwords are permitted. On the other hand, this check during the entry does not exist in many industrial devices, since their running time is frequently significantly longer than in classic IT, and this check established as a standard is not yet present in very old devices.

### SUMMARY

Against this background, teachings of the present disclosure include improved methods for ensuring IT security of an automation system, with which in particular the problem of weak authentication information can be countered and improved security systems with which such an improved method can be carried out. For example, some embodiments include a method for ensuring IT security of an automation system, in which a piece of authentication information previously provided for authentication at an end point of the automation system is checked for a minimum IT security requirement and then, if the piece of authentication information does not meet the minimum IT security requirement, a new piece of authentication information is generated, and in which an authentication module (TC) is enabled to authenticate (UPW) at the end point (DEV) by providing the authentication module with the new piece of authentication information.

In some embodiments, the piece of authentication information is a password.

In some embodiments, the minimum requirement is formed with a minimum length or with a minimum complexity, in particular utilization of a stock of symbols, of the authentication information.

In some embodiments, the authentication module (TC) emulates an entry of the authentication information, in particular a keyboard entry of the authentication information.

In some embodiments, a piece of meta-information from the in particular new authentication information, in particular a period of use and/or a validity time period and/or an age of the authentication information and/or a complexity value indicating a complexity of the authentication function and/or a functional value of a one-way function applied to the authentication information, is stored.

In some embodiments, the method is carried out repeatedly, in particular at regular time intervals, and a check is made on the basis of the piece of meta-information as to whether the minimum requirement is met.

In some embodiments, the piece of authentication information and/or meta-information previously provided is subjected to a comparison (PPW) with authentication information and/or meta-information from preceding or revealed security incidents and, depending on the comparison (PPW), it is assessed whether the minimum requirement is met.

In some embodiments, the authentication module (TC) is designed for authentication by means of an emulation of an entry of the new piece of authentication information.

In some embodiments, the authentication module (TC) is set up and designed for the cryptographically protected storage of the new authentication information.

In some embodiments, the automation system is a production system and/or a process technology system.

In some embodiments, the endpoint (DEV) comprises at least one production tool and/or an in particular industrial control device and/or a process technology device.

As another example, some embodiments include a security system for an automation system, which has a check module which is designed to check a piece of authentication information previously provided for authentication at an end point of the automation system for a minimum IT security requirement, and a generation module which is designed to generate a new piece of authentication information when the authentication information does not meet the minimum IT security requirement, and an authentication module (TC) to which the piece of authentication information can be delivered for the authentication (UPW) at the end point (DEV) using the new piece of authentication information, or which has the generation module.

### BRIEF DESCRIPTION OF THE DRAWINGS

The teachings of the present disclosure are explained in more detail below by using an exemplary embodiment illustrated in the drawing. The single FIGURE shows an exemplary embodiment of a method incorporating teachings of the present disclosure for ensuring IT security of an automation system, schematically in a basic outline.

### DETAILED DESCRIPTION

The teachings include a method for ensuring IT security of an automation system, wherein a piece of authentication information previously provided for authentication at an end point of the automation system is checked for a minimum IT security requirement and then, if the piece of authentication information does not meet the minimum IT security requirement, a new piece of authentication information is generated and an authentication module is enabled to authenticate at the end point by providing the authentication module with the new piece of authentication information. Authentication at the end point is possible by means of the authentication module at the end point of the automation system. A new piece of authentication information can be generated if a previously provided piece of authentication information does not meet the minimum IT security requirement, so that the new piece of authentication information then meets the minimum requirement.

For this purpose, the minimum requirement is chosen to be sufficiently high in accordance with the current prior art and matched to the security demand of the automation system. Consequently, choosing too weak a piece of authentication information, in particular in the form of too weak a password, can be ruled out. The IT security of the automation system is consequently ensured even when authentication information for end points of the automation systems in the meantime do not or no longer meet the minimum requirement, for example because the minimum requirement has increased in the meantime or because authentication information has been added by new users of the automation system. This is because the authentication information is updated in such a way that the minimum requirement is met.

In automation systems authentication information can be set locally. The minimum requirements on the authentication information comprise minimum requirements on length of the authentication information and a specific complexity of the authentication information. In particular, the length and/or the complexity of authentication information have a critical influence on the security of authentication information. A deviation from a predefined minimum requirement can be detected substantially without any interaction of users with the end point, and the end point can automatically—without any user interaction—be transferred again into a secure state with sufficiently strong authentication information.

It is consequently not necessary to generate a piece of authentication information for the end point in every case, instead a new piece of authentication information is generated only when the authentication information previously provided for the end point with regard to IT security is not sufficiently secure in the sense of the minimum requirement. In this way, the methods incorporating teachings of the present disclosure changes planned operating sequences during the operation of the automation system only to such an extent as is necessary to ensure the intended IT security. On the other hand, the operating sequence remains unchanged if the intended IT security is in any case still ensured.

The methods described herein can be carried out in a completely computer-implemented manner, so that a security-critical human operating behavior which can impair the IT security of end points of the automation system and thus also of the automation system for reasons of convenience or for habitual reasons can be effectively countered. In some embodiments, the authentication module is provided with the new piece of authentication information in such a way that the new piece of authentication information is generated by the authentication module.

In some embodiments, the minimum requirement is formed with a minimum length or with a minimum complexity, in particular a use of a stock of symbols, of the piece of authentication information. Thus, the minimum complexity can necessitate use of a stock of symbols with which the authentication information is formed. A minimum complexity can in particular comprise use of special characters and/or at least one uppercase letter and at least one lowercase letter and/or numbers in passwords.

In some embodiments, a piece of meta-information from the new piece of authentication information, in particular a period of use and/or a validity time period and/or an age of the piece of authentication information and/or a complexity value indicating a complexity of the authentication function and/or a functional value of a one-way function applied to the piece of authentication information, is stored. In some embodiments, such a functional value is a hash value of a hash function applied to the piece of authentication information. By means of such hash values, it is possible, in an easy and information-secure manner, to check whether for example pieces of authentication information correspond to authentication information which has been ruled out and which are not permissible on account of the minimum requirement.

The piece of authentication information is suitably a password. In some embodiments, the minimum requirement comprises a minimum length of the password and/or a minimum complexity of the password. Expediently, in particular, the use of specific character categories for the password can be required and/or trivial or already openly published or generally known passwords can be ruled out. The password length can also be restricted or adapted via specifications of the end point. Such pieces of authentication information that are ruled out can be, for example, passwords which have reached the public realm in data breaches that have become known and which therefore are not to be used once more, or which are known as notoriously weak passwords, for example “Password”, “123456”, “qwert” or else also known names such as “Christoph”.

In some embodiments, the method is carried out repeatedly, in particular at regular time intervals, and a check may be made on the basis of the piece of meta-information, i.e. by using the meta-information, it is assessed whether the minimum requirement is met. Because of the repetition of the method, in particular at regular time intervals, the IT security of an automation system can be ensured permanently with regard to the authentication information. In particular, end points newly introduced into the automation system in the meantime can newly be subjected to a check. Also, the minimum requirement can be matched to current standards relating to IT security and pieces of authentication information that have in the meantime become known from security gaps or other incidents relevant to IT security and in the meantime alleged to be insecure can be recorded, in particular in the manner of a blacklist. In this development, the minimum requirement therefore remains perpetually up-to-date. In addition, it is possible to react to changes in the authentication information that have been performed in the meantime, for example as a result of newly added users of end points, if in the meantime pieces of authentication information assessed as insecure are used.

In particular by using the meta-information, it is easily possible to check and assess whether in general or in the meantime authentication information assessed as insecure is used, for example by using an age of use or by using a hash value or by using a piece of complexity information of the authentication information. In addition, checking by using the meta-information does not require the direct checking at the end points themselves, instead it is possible to refer back to the stored meta-information relating to the authentication information of the end points in order to check the authentication information. In this way, repeating the check can be carried out at a particularly high frequency, since the check of the meta information itself requires no direct interaction of users with the end points themselves.

In some embodiments, a piece of authentication information and/or meta-information previously provided is subjected to a comparison with authentication information and/or meta-information from preceding or revealed security incidents and, depending on the comparison, it is assessed whether the minimum requirement is met. In this development, it is possible to react to incidents in the past which are relevant to IT security. In particular, authentication information that has previously been used but in the meantime has been assessed as insecure can thus advantageously be ruled out.

In some embodiments, the authentication module is designed and set up to deliver the authentication information to the end point. In this way, a user can refer to the end point in that the user delivers the authentication information to the end point using the authentication module. Consequently, the user does not have to enter the authentication information manually at the respective end point, instead the authentication information can be stored directly in the authentication module and delivered to the end point as required. The authentication module can be enabled by means of a piece of user authentication information, for example by means of a master password of a specific user, so that the authentication module can deliver the authentication information to the end point after it has been enabled by the user.

In some embodiments, the authentication module is designed for authentication by means of an emulation of an entry of the authentication information. This means that use is made of such an authentication module which is designed for authentication by means of an emulation of an entry of the piece of authentication information. In this way, authentication information can be delivered in a manner known per se via a keyboard interface, users not having to enter the authentication information manually. In some embodiments, the authentication information does not have to be remembered but can automatically be retrieved from a memory of the authentication module.

The authentication information is stored in a cryptographically protected manner in the authentication module. Expediently, an authentication module which is set up and designed for the cryptographically protected storage of the authentication information is used for this purpose. In this development, the IT security is not impaired even if an unauthorized attacker gains access to the authentication module. In some embodiments, the authentication module is hardware-secured, so that even in the event of a physical access to the authentication module, reading the authentication information is not successful or successful only with a great deal of effort. In particular, the authentication module is hardware-secured by means of a hardware-based key store.

In some embodiments, the automation system is a production system and/or a process technology system. In some embodiments, the automation system is an industrial automation system and/or a control system, in particular an industrial control system.

The end point is at least one production tool and/or an in particular industrial control device, e.g. a control device of the automation system, and/or a process technology device or the end point comprises such a production tool and/or control device and/or process technology device.

Some embodiments include a security system for an automation system designed to carry out one or more of the methods described herein for ensuring IT security of the automation system. The security system has a check module for this purpose, which is designed to check a piece of authentication information previously provided for authentication at an end point of the automation system for a minimum IT security requirement. The security system additionally has a generation module, which is designed to generate a new piece of authentication information when the authentication information does not meet the minimum IT security requirement. In addition, the security system has an authentication module to which the new piece of authentication information can be delivered for the authentication at the end point using the new piece of authentication information, or which has the generation module. By means of the security system, the methods described herein can be carried out and the IT security of the automation system can be ensured. Expediently, the authentication module is designed to deliver the new piece of authentication information to the end point.

In the method illustrated in the FIGURE, the IT security of an automation system in the shape of a digitally controlled production system is ensured in that authentication at end points of the automation system with increased IT security is made possible. In principle, in further exemplary embodiments not specifically illustrated, the automation system can also be a process technology system or another automation system. In the present case, it is an industrial automation system.

In the exemplary embodiment shown, a device DEV in the shape of a control device of the automation system forms an end point, at which the authentication is improved by means of the methods described herein. In the device DEV, a strength of a password for the authentication at the device DEV is checked at regular time intervals by means of a password verification platform TPF. Here, the strength of the password is to be understood as a complexity of the password. This complexity is checked by using a length of the password and by using a used range of characters of the password, i.e., for example, by using the fact as to whether special characters are contained in the password or not, and by using a time of storage of the password. The time of storage of the password indicates the time since which the password has been in use.

Furthermore, to check the strength of the password, a hash value of the password is used, which is compared with hash values from earlier passwords. The hash value of the password permits a check as to whether the currently allocated password has already been allocated at an earlier time, for example whether only two passwords are continuously used alternately or whether regular updating of the password with passwords that have not been used previously is carried out. By using these criteria, the strength of the password is checked and subjected to a comparison SPW with a minimum strength of the password. If the comparison SPW supplies the presence J of a minimum strength of the password, then the regular checking of the password of the device DEV at regular time intervals is continued. If, on the other hand, the comparison SPW indicates the lack N of a minimum strength of the password, then a trustworthy component TC performs the password management, as described below:

The trustworthy component TC is designed as a root of trust, which has encrypted memories and cryptographically protected processors, which are protected against software and hardware manipulations. The trustworthy component TC comprises a password generation module, by means of which, in a password generation step GSP, a secure password is generated for the device DEV. Here, “secure” password means that the password has the strength required above.

In a password setting step SSP, the password is then set as a password for the authentication at the device DEV. Meta-information from the password set in the password setting step SSP, and the password itself, are stored in a password memory PWS. This meta-information includes a hash value of the password and the generation time of the generation of the password. By means of the meta-information from the password memory PWS, checks PPW of the passwords can then be carried out at short time intervals as to whether the password stored in the password memory PWS for the device DEV has been used in preceding security incidents, for example in a recorded unauthorized authentication at the device DEV. In this case, the password is assessed as compromised and a new password for the device DEV is generated by means of a renewed password generation step GPW. A comparison of the passwords from security incidents and the password currently stored for the device DEV can be carried out by means of a comparison of the hash values, so that no comparison of the passwords in plain text is required for the comparison.

In addition, the checks PPW of the passwords can comprise a check PPW of the passwords by using the generation times and, in the case of passwords that are too old, a renewed password generation step GPW for a new password for the device DEV can be triggered. A permissible maximum age for the passwords and a list of hash values of compromised passwords are recorded in a password protocol, which is stored in the trustworthy component TC in a protocol memory GLS and is updated continuously. Also recorded in the password protocol is the required strength of the password already mentioned above. In some embodiments, the password protocol can also be recorded in such a protocol memory GLS which is not part of the trustworthy component TC but is merely consulted by the trustworthy component TC in order to read the password protocol.

The password from the password memory which, in this way, is sufficiently strong and kept up-to-date is then read from the password memory PWS when a user wishes to access the device DEV and is delivered to the device DEV in a transmission step UPW, directly or wirelessly by means of a cryptographically protected connection via a device carried along by the user, in the exemplary embodiment illustrated by means of a Bluetooth dongle, via a keyboard emulation. In some embodiments, the password can also be delivered to the device DEV in another way.

The device DEV then checks the password and allows the user access to the device DEV.

The password protocol from the protocol memory GLS is simultaneously used to undertake the strength of the password in the comparison SPW. It is therefore ensured that only passwords with a minimum strength and with a sufficient currency can be used for authentication on the device DEV.

In the exemplary embodiment illustrated, the passwords are stored in a cryptographically protected manner in the password memory PSW, so that the passwords are not present in plain text in the password memory PWS.

The password verification platform TPF and the trustworthy component TC, together with the password generation module and the password memory PWS and the protocol memory GLS, and, optionally, the possibly present device carried along by the user form the security system. In some embodiments, the protocol memory GLS is not part of the security system, instead the security system merely has an interface to a protocol memory GLS.

What is claimed is:

1. A method for ensuring security of an automation system, the method comprising:
checking a piece of authentication information previously provided for authentication at an end point of the automation system for a minimum security requirement;
if the piece of authentication information does meet the minimum security requirement, using an authentication module to authenticate at the end point;
else, if the piece of authentication information does not meet the minimum security requirement, generating a new piece of authentication information, and providing the authentication module with the new piece of authentication information to authenticate at the end point.

2. The method as claimed in claim 1, wherein the piece of authentication information comprises a password.

3. The method as claimed in claim 1, wherein the minimum requirement comprises a minimum length or a minimum complexity of the authentication information.

4. The method as claimed in claim 3, wherein the authentication module emulates an entry of the authentication information.

5. The method as claimed in claim 1, further comprising storing a piece of meta-information from the in particular new authentication information.

6. The method as claimed in claim 5, further comprising repeating the method and checking the piece of meta-information to determine whether the minimum requirement is met.

7. The method as claimed in claim 1, further comprising subjecting the piece of authentication information and/or meta-information previously provided to a comparison with authentication information and/or meta-information from preceding or revealed security incidents and, depending on the comparison assessing whether the minimum requirement is met.

8. The method as claimed in claim 1, wherein the authentication module is designed for authentication using an emulation of an entry of the new piece of authentication information.

9. The method as claimed in claim 1, wherein the authentication module is set up and designed for cryptographically protected storage of the new authentication information.

10. The method as claimed in claim 1, wherein the automation system comprises a production system and/or a process technology system.

11. The method as claimed in claim 1, wherein the endpoint comprises at least one production tool and/or an industrial control device and/or a process technology device.

12. A security system for an automation system, the security system comprising:
a check module to check a piece of authentication information previously provided for authentication at an end point of the automation system for a minimum security requirement; and
a generation module to generate a new piece of authentication information if the authentication information does not meet the minimum security requirement; and
an authentication module to receive the piece of authentication information for the authentication at the end point using the new piece of authentication information.
